(19) United States
(12) Patent Application Publication
(10) Pub. No.: US 2017/0010898 A1
(43) Pub. Date: Jan. 12, 2017

(54) SYSTEM FOR CONVENIENTLY MOVING AN ENTIRE COMPUTER ENVIRONMENT AMONG A PLURALITY OF COMPUTING PLATFORMS

(71) Applicants: Raymond Lopez Robles, Lake Havasu City, AZ (US); Daniel Lee Cook, Albuquerque, NM (US)

(72) Inventors: Raymond Lopez Robles, Lake Havasu City, AZ (US); Daniel Lee Cook, Albuquerque, NM (US)

(21) Appl. No.: 15/273,242

(22) Filed: Sep. 22, 2016

Related U.S. Application Data
(63) Continuation-in-part of application No. 12/883,277, filed on Sep. 16, 2010, now abandoned.

(51) Int. Cl. G06F 9/44; G06F 21/57; G06F 9/455

(52) U.S. Cl. CPC G06F 9/4406; G06F 9/45554; G06F 21/572

(57) ABSTRACT

A system is provided for conveniently moving an entire computer environment among a plurality of computing platforms. The system includes a portable storage medium able to couple to a host machine of a computing platform. The portable storage medium stores an emulator program able to run a guest operating system (OS) and an executable script able to prepare and launch a computer environment based on the guest OS. The host machine includes a computer environment based on a native operating system (OS), the native OS being able to detect and mount the portable storage medium, the native OS also being able to execute the executable script.

### CROSS REFERENCE TO RELATED PATENT APPLICATIONS

This patent application is a continuation-in-part of U.S. patent application Ser. No. 12/883,277, titled “SYSTEM FOR CONVENIENTLY MOVING AN ENTIRE COMPUTER ENVIRONMENT AMONG A PLURALITY OF COMPUTING PLATFORMS,” filed on Sep. 16, 2010. This patent application claims priority and benefit to U.S. patent application Ser. No. 12/883,277, titled “SYSTEM FOR CONVENIENTLY MOVING AN ENTIRE COMPUTER ENVIRONMENT AMONG A PLURALITY OF COMPUTING PLATFORMS,” under 35 U.S.C. §120. Patent application Ser. No. 12/883,277 is herein incorporated by reference in its entirety.

### TECHNICAL FIELD

The present invention relates generally to the field of virtual and emulated personal computing environments, and more particularly to portable virtual computing environments.

### BACKGROUND

Modern personal computers are increasingly pervasive in both business and personal environments. Additionally, personal computers are increasingly designed for mobility and functionality that supports both business and personal activities, leading to small, lightweight, full-featured electronic devices. However, even as personal computers continue to shrink in size and weight, typical personal computers are still complex hardware systems configured with an operating system. In typical systems, the operating system supports software applications that perform the user-desired functions.

The typical modern operating system is highly hardware-oriented—the operating system must be configured for the particular hardware on which it runs. One configuration of Unix, for example, that runs on a particular hardware processor, motherboard, memory, etc., will not run on a different platform without reconfiguration or, at the very least, thorough compatibility testing. This configuration and compatibility testing is beyond the ability of the typical consumer user.

Furthermore, modern operating systems offer a wide array of features. Increasing competition has lead to significant variation in operating systems available for the typical consumer to choose. In some cases, no one operating system meets all of a consumer's needs. As such, personal computers are increasingly configured with multiple operating systems. However, in typical systems, the user can only access one operating system at a time. Further, switching between operating systems is frequently a time-consuming and annoying task for the typical consumer user.

Moreover, the hardware of typical personal computers is complex. The typical consumer user does not know or understand how the various components interact, what functions they perform, or how they are constructed. Accordingly, the typical consumer user cannot troubleshoot hardware problems that arise in a typical personal computer without extensive, often expensive, training. This problem is exacerbated by the sometimes obscure relationship between the operating system and the particular hardware on which it runs. Thus, in some cases, the user experiences a problem that is neither a pure hardware or software fault, but is instead a peculiar error arising from that particular hardware and software combination. Diagnosing and correcting such errors is usually far beyond the ability of the typical consumer user, and even exceeds the ability of some professional technicians.

Finally, typical personal computers offer a wide range of customization options to the consumer user. Some users spend hours adjusting these customization options until their personal experience, usually as expressed through the user interface, is optimized to their personal preferences. But these personalization options do not persist across multiple machines. For a user that typically operates both a business machine and a personal machine, the user must duplicate optimization efforts on each machine. Further, the different machines may require subtle configuration differences that add to the frustration and time expense of the user trying to personalize his computing experience.

### SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

In a general aspect of the invention, a system is provided for conveniently moving an entire computer environment among a plurality of computing platforms. The system includes a portable storage medium able to couple to a host machine of a computing platform. The portable storage medium stores an emulator program able to run a guest operating system (OS) and an executable script able to prepare and launch a computer environment based on the guest OS. The host machine includes a computer environment based on a native operating system (OS), the native OS being able to detect and mount the portable storage medium, the native OS also being able to execute the executable script.

In a preferred embodiment, the computer environment based on the guest OS isolates sensitive information from access from within the computer environment based on the native OS. In another embodiment, the native OS executes the executable script automatically.

In another preferred embodiment, the native OS is one of: a Unix-type OS, a Linux-type OS, a Windows-type OS, a Macintosh-type OS, and a modern-type OS. In another embodiment, the guest OS is one of: a Unix-type OS, a Linux-type OS, a Windows-type OS, a Macintosh-type OS, and a modern-type OS. In another embodiment, native OS is one of: a Unix-type OS, a Linux-type OS, a Windows-type OS, a Macintosh-type OS, and a modern-type OS; and the guest OS is one of: a Unix-type OS, a Linux-type OS, a Windows-type OS, a Macintosh-type OS, and a modern-type OS. In another embodiment, the computer environment based on the guest OS is further configured to appear to a user as one of a conventional desktop computer environment or a conventional laptop computer environment.

In yet another preferred embodiment, the portable storage medium is one of: a solid-state USB flash drive; a USB-capable traditional hard drive; a MiniSD card; a MicroSD card; a data storage module of a mobile telephone; a data storage module of a camera; a data storage module of an MP3 device; an online storage account; a static network drive; a dynamic network drive; and a drive distributed across networks.

In still another preferred embodiment, the portable storage medium further includes a plurality of guest OS files usable by the emulator program and the executable script to launch the computer environment based on the guest OS. In another preferred embodiment, the computer environment based on the guest OS is executable as a process that does not require administrator rights within the native OS.

In another general aspect of the invention, a method is provided for conveniently moving an entire computer environment among a plurality of host computers, each host computer having a native computer environment based on a native operating system (OS), the native OS being able to detect and mount a portable storage medium, the native OS also being able to execute an executable script. The method includes providing a portable storage medium and storing on the portable storage medium: an emulator program able to run a guest operating system (OS); and an executable script able to prepare and launch a guest computer environment based on the guest OS. The method includes attaching the portable storage medium to a host computer and running the guest operating system (OS) on the host computer. The method includes preparing and launching a computer environment based on the guest OS.

In a preferred embodiment, the guest computer environment based on the guest OS isolates sensitive information from access by a user within the native computer environment based on the native OS. In another embodiment, the native OS automatically executes an executable script to prepare and launch the guest computer environment based on the guest OS.

In another preferred embodiment, the native OS is one of: a Unix-type OS, a Linux-type OS, a Windows-type OS, a Macintosh-type OS, and a modern-type OS. In another embodiment, the guest OS is one of: a Unix-type OS, a Linux-type OS, a Windows-type OS, a Macintosh-type OS, and a modern-type OS. In another embodiment, native OS is one of: a Unix-type OS, a Linux-type OS, a Windows-type OS, a Macintosh-type OS, and a modern-type OS; and the guest OS is one of: a unix-type OS, a Linux-type OS, a Windows-type OS, a Macintosh-type OS, and a modern-type OS.

In yet another preferred embodiment, the method includes providing a plurality of guest OS files usable to launch the guest computer environment based on the guest OS. In another embodiment, the guest computer environment based on the guest OS is executable as a process that does not require administrator rights within the native OS. In another embodiment, the computer environment based on the guest OS provides access to at least a portion of the host system hardware.

In yet another preferred embodiment, the portable storage medium is a USB flash drive. In another embodiment, the portable storage medium is one of: a solid-state USB flash drive; a USB-capable traditional hard drive; a MiniSD card; a MicroSD card; a data storage module of a mobile telephone; a data storage module of a camera; a data storage module of an MP3 device; an online storage account; a static network drive; a dynamic network drive; and a drive distributed across networks.

The aforementioned aspects and other objectives and advantages can now be achieved as described herein. Systems and methods for conveniently moving an entire computer environment among a plurality of computing platforms comprise a portable storage medium able to couple to a host machine of a computing platform, the portable storage medium storing a single executable file configured to prepare and launch a computer environment based on a guest OS; and the host machine including a computer environment based on a native operating system (OS), the native OS being able to detect and mount the portable storage medium, the native OS also being able to execute the single executable file.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 is a generalized block diagram showing a system configured with a portable virtualized computing environment with universal inter-operability;

FIGS. 2-4 are high-level flow diagrams illustrating an exemplary operational session of the portable virtualized computing environment with universal inter-operability of FIG. 1;

FIG. 5 illustrates a generalized block diagram showing a system configured with a portable virtual machine with universal inter-operability; and

FIG. 6 is a high level flow diagram illustrating an exemplary operational session of a portable virtual machine with universal inter-operability of FIG. 5.

### DETAILED DESCRIPTION

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment, and the phrase “in another embodiment” as used herein does not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

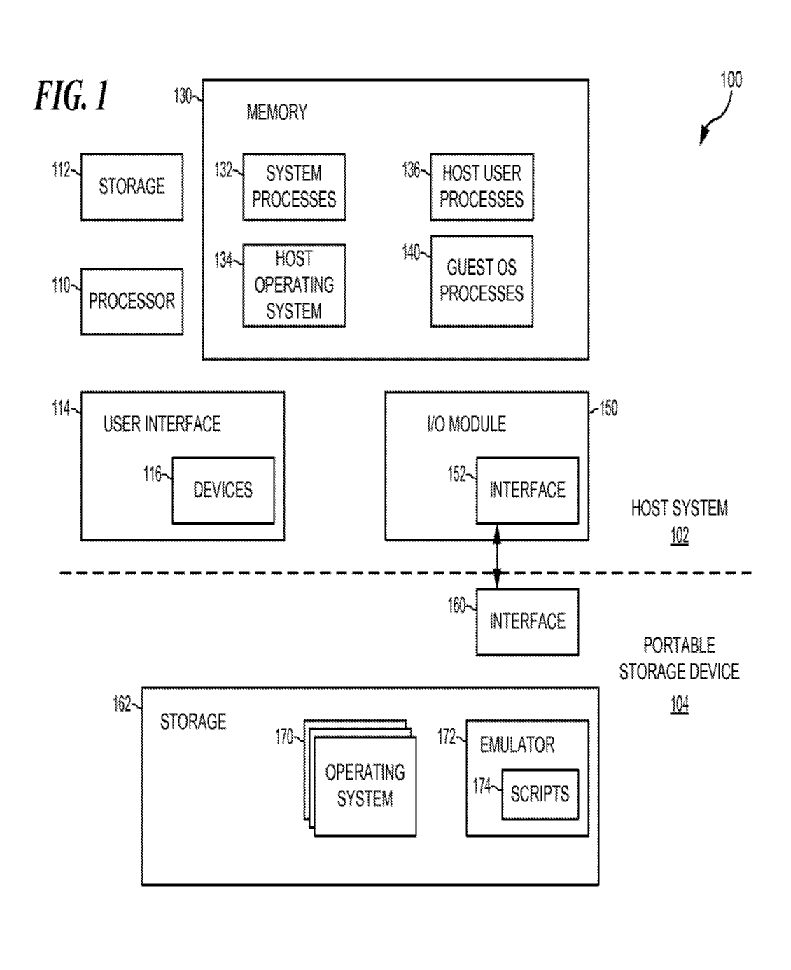

FIG. 1 is a block diagram showing an embodiment of the invention for a portable virtualized computing environment with universal inter-operability. Specifically, FIG. 1 shows a computer system 100 having a host system 102 supporting a portable storage device 104, as described in more detail below. Generally, system 100 provides for conveniently moving an entire computer environment among a plurality of computing platforms, as described in more detail below.

In the illustrated embodiment, host system 102 is an otherwise conventional personal computer system, configured with a modern operating system, as described in more detail below. Specifically, host system 102 includes an otherwise conventional processor 110, and an otherwise conventional storage 112. Generally, processor 110 is configured to execute instructions and storage 112 is configured to store data in a persistent, non-volatile state. One skilled in the art will understand that storage 112 is therefore distinct from “memory,” as described in more detail below.

Host system 102 also includes a user interface 114. Generally, user interface 114 is an otherwise conventional user interface, configured to receive user input from a user and to display information to a user. As such, user interface 114 includes a number of devices 116. Generally, devices 116 are otherwise conventional user interface hardware devices, such as keyboards, mice, monitors, speakers, and other suitable devices for receiving information from and/or presenting information to a user.

Host system 102 also includes memory 130. Memory 130 is an otherwise conventional memory, such as a dynamic random access memory (DRAM) or other memory able to serve as main memory for host system 102. One skilled in the art will understand that memory 130 stores data and instructions for processing and execution by host system 102.

For example, in the illustrated embodiment, memory 130 includes tem processes 132, host operating system (OS) 134, host user processes 136, and guest operating system (OS) processes 140. Generally, system processes 132 are processes (and associated data) executing on behalf of the host system 102 itself, and not, for example, as a particular user. In typical systems, system processes 132 are processes governed by the operating system. As described in more detail below, system processes 132 ordinarily require a heightened privilege level than, for example, ordinary user processes.

As illustrated, memory 130 includes host OS 134. Generally, host OS 134 is an otherwise conventional modern operating system. Specifically, in one embodiment, host OS 134 is configured to recognize portable storage media, and to execute (or “run”) scripts, such as JavaScript, for example. Example suitable operating systems include, but are not limited to, Windows-type operating systems, Unix-type operating systems, Macintosh-type operating systems, mobile-type operating systems, and modern-type operating systems.

Generally, a Windows-type operating system is an operating system from the Windows family of operating systems (such as Windows 7, Windows Vista, and Windows XP, for example), or clones thereof. Generally, a Unix-type operating system is an operating system from the Unix family of operating systems (such as one of the various versions of Unix), a derivative of Linux (such as Debian, Ubuntu, and Red Hat, for example), or other modification of Unix (such as AIX, for example), or clones thereof. Generally, a Macintosh-type operating system is an operating system from the Apple Macintosh operating system family (such as OSX and Snow Leopard, for example), or clones thereof. Generally, a mobile-type operating system is an operating system oriented for use on mobile and/or embedded platforms, such as mobile telephones, smartphones, personal data assistants (PDAs), portable music players, and other such devices. Mobile-type operating systems include, for example, Android, iPhone, iTouch, Windows Mobile, and Linux Mobile. Generally, a modern-type operating system is an operating system configured with modern features, such as features that enable detection and mounting of external storage.

In addition to system processes 132, Host OS 134 also creates and launches host user processes 136, which also reside in memory 130. In one embodiment, host user processes 136 are otherwise conventional user processes, as configured based on the particular host OS 134 in operation. One skilled in the art will understand that host user processes 136 are typically configured based on user input and/or the operation of user applications operating on the user's behalf. Generally, a user operating host system 102 does so through host user processes 136 (and user interface 114).

As described in more detail below, memory 130 also includes guest operating system (as) processes 140. Generally, guest as processes 140 are processes operating on behalf of a guest OS, in a virtualized computing environment provided by portable storage device (PSD) 104. Generally, in one embodiment, guest OS processes 140 are non-privileged processes on host system 102. In an alternate embodiment, guest OS processes 140 are configured with the ordinary privilege level of host user processes 136.

Thus, generally, host system 102 provides a computer environment based on a particular OS, with features that support a guest OS. As used herein, a “computer environment based on a particular OS” includes a computer environment wherein operating system files are located on the hardware providing the computer environment.

Host system 102 also includes an input/output (I/O) module 150. I/O module 150 is an otherwise conventional I/O module, and includes interface 152. Generally, interface 152 is an otherwise conventional I/O interface, configured to receive portable storage devices. In one embodiment, interface 152 is an otherwise conventional (female) universal serial bus (USB) port. Broadly, interface 152 is configured to couple to an interface 160 of PSD 104, as described in more detail below.

As shown, PSD 104 is a portable storage device, configured as described herein. Generally, PSD 104 is an electronic storage device, configured for portable, universal inter-operability. PSD 104 can be configured as any suitable portable storage medium that allows read/write capability and an appreciable read/write speed. As such, exemplary PSD 104 include, but are not limited to: solid-state e USB ‘flash’ drives, USB hard drives with traditional hard drives, MiniSD cards, MicroSD cards, storage located on a mobile phone, storage located on a camera, storage located on an MP3 device, online storage facilities and accounts, static and dynamic network drives, mapped drives across networks.

One skilled in the art will understand that universal inter-operability depends on the interface configuration of PSD 104. Thus, as shown in the illustrated embodiment, PSD 104 includes an interface 160. Generally, interface 160 is an otherwise conventional interface, configured to couple to an interface 152 or a host system 102. One skilled in the art will understand that there are a variety of well-known, interface standards, such as USB and Firewire, for example. As such, in one embodiment, interface 160 is an otherwise conventional (male) USB port.

As illustrated, PSD 104 also includes storage 162. Generally, storage 162 is otherwise conventional non-volatile storage, suitable to store and retain data across multiple sessions, whether connected to or disconnected from a host system 102. Generally, storage 162 includes features embodying certain aspects of the invention.

Specifically, storage 162 includes operating system files 170 and emulator 172. Generally, operating system files 170 are files containing information regarding emulation and operation of one or more particular operating systems in a virtualized environment. One skilled in the art will understand that the files and data necessary to operate an installed operating system, such as host OS 134, are not necessarily identical to those files and data necessary to operate that same operating system in a virtualized environment. For example, as described above, installed operating systems typically must be customized for the particular hardware on which the operating system is installed. In one embodiment, operating system files 170 are configured for a virtual computing environment that operates independent of any specific hardware configuration.

Very generally, emulator 172 uses operating system files 170 to initialize and execute a virtualized computing environment (VCE), which runs on host system 102 as guest OS processes 140. As such, in one embodiment, emulator 172 is an otherwise conventional virtual machine emulator, modified as described herein. In one embodiment, emulator 172 uses scripts 174 to configure, initialize, and operate a guest OS in a VCE, as described in more detail below.

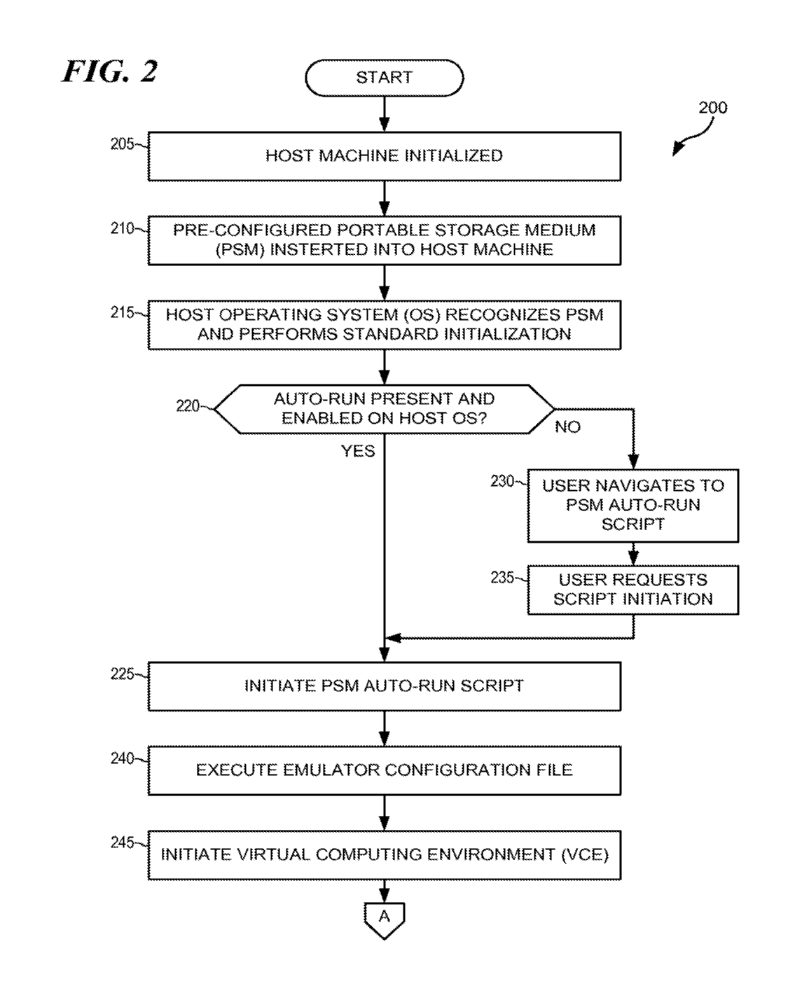

Specifically, in one embodiment, PSD 104 is configured to configure, initialize, and operate a guest OS in a VCE as described with respect to FIGS. 2 through 4. As indicated at block 205, the process begins and the host machine is initialized. As described above, in one embodiment, after initialization, the host machine is running a modern-type operating system. As described above, a modern-type operating system includes, for example, Unix-, Linux-, Windows-, and Macintosh-type operating systems. One skilled in the art will understand that other suitable modern-type operating systems can also be employed.

Next, as indicated at block 210, the user inserts a pre-configured portable storage medium (PSM) into the appropriate port/interface on the host machine. Next, as indicated at block 215, the host OS recognizes the PSM and the host machine/OS performs a standard PSM initialization. One skilled in the art will understand that a typical modern-type OS can be configured to recognize and mount PSM devices in standard configurations, such as, for example, USB, Firewire, and other suitable configuration protocols.

Next, as indicated at decisional block 220, the host OS determines whether auto-run features are enabled (or present) on the host machine/OS. If at decisional block 220 auto-run features are enabled, the process continues along the YES branch to block 225. Next, as indicated at block 225, the host OS initiates the PSM auto-run script and the process continues to block 240, described below.

If at decisional block 220 auto-run features are not enabled, the process continues along the NO branch to block 230. Next, as indicated at block 230, the user navigates to the PSM auto-run script on the PSM. In one embodiment, the user accesses the PSM scripts through a graphical user interface (GUI) on the host machine. Next, as indicated at block 235, the user requests the auto-run script be initiated. The process continues to block 225, wherein the auto-run script is initiated.

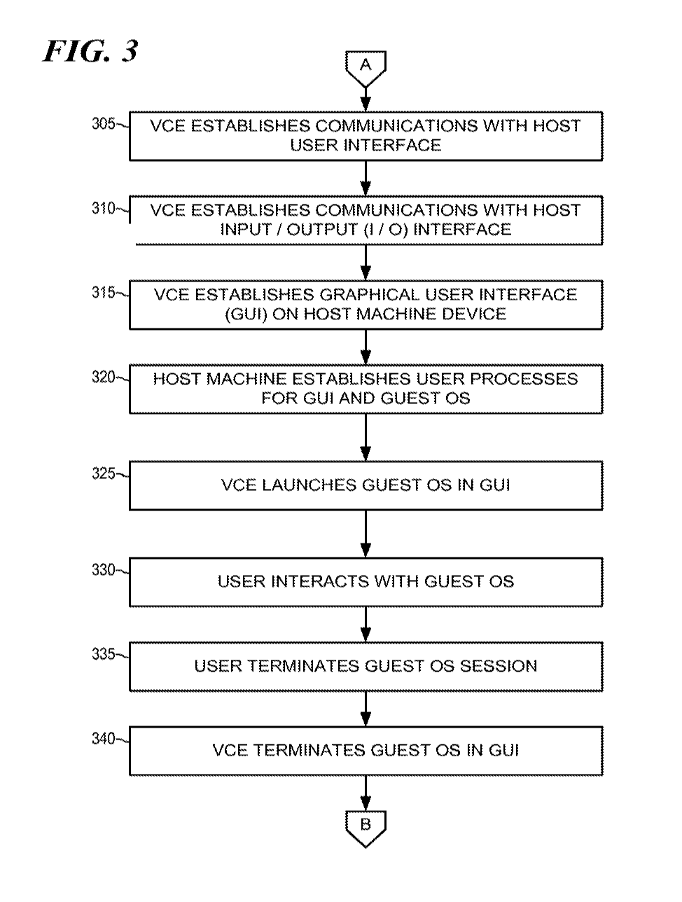

Next, as indicated at block 240, the PSM executes the emulator configuration file. As described above, this step can be performed by the PSM executing as a user-level process on the host OS. Next, as indicated at block 245, the PSM initiates a virtual computing environment (VCE). In one embodiment, the PSM initiates a VCE using the emulator configuration files and the OS files. As described above, in one embodiment, the VCE runs as a user-level process, within a user interface embedded in a GUI on the host OS. The process continues to marker “A” of FIG. 3.

As indicated at marker “A” of FIG. 3, the process continues to block 305. As indicated at block 305, the VCE establishes communications with the host machine/OS user interface. Next, as indicated at block 310, the VCE establishes communications with the host machine/OS input/output (I/O) interface. Next, as indicated at block 315, the VCE establishes a GUI on the host machine device.

Next, as indicated at block 320, the host machine establishes users processes for the VCE GUI and guest OS. Next, as indicated at block 325, the VCE launches the guest OS in the GUI. Next, as indicated at block 330, the user interacts with the guest OS. One skilled in the art will understand that the user interaction with the guest OS can be any of a wide variety of interactions, as, for example, a user would undertake in an ordinary computing environment. After a period of time, the user has finished whatever tasks the user performed.

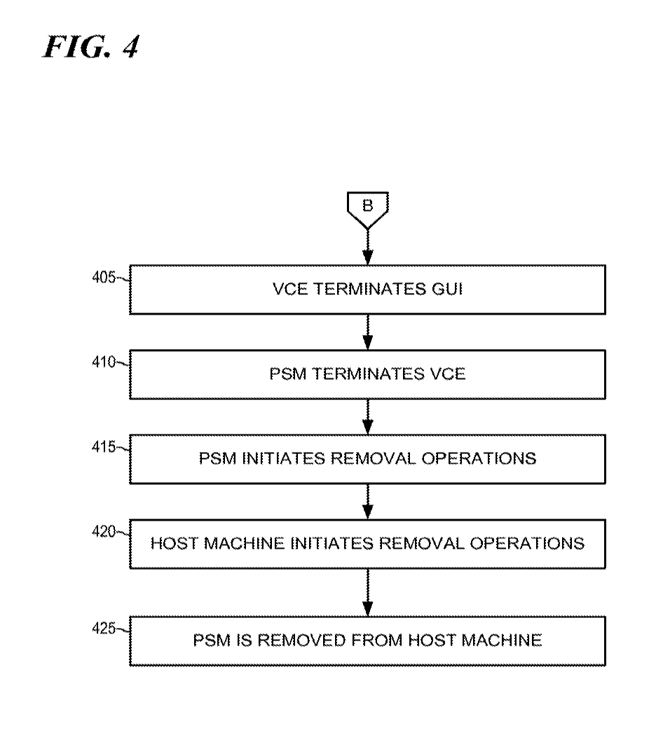

Next, as indicated at block 335, the user terminates the guest OS session. Next, as indicated at block 340, the VCE terminates the guest OS in the GUI. The process continues to marker “B” of FIG. 4.

As indicated at marker “B” of FIG. 4, the process continues to block 405. As indicated at block 405, the VCE terminates the GUI. In one embodiment, the VCE saves the user configuration for the VCE. In another embodiment, the host OS terminates the GUI. Next, as indicated at block 410, the PSM terminates the VCE. Next, as indicated at block 415, the PSM initiates removal operations. As described above, in one embodiment, removal operations include decoupling from the host machine power supply, requesting dismount, requesting ejections, and/or other suitable operations.

Next, as indicated at block 420, the host machine initiates removal operations. As described above, in one embodiment, the host machine removal operations include removing power from the PSM, dismounting the PSM as a drive on the hose machine, killing open tasks running on the PSM, and/or other suitable operations. Next, as indicated at block 425, the user removes the PSM from the host machine and the process ends.

One skilled in the art will appreciate that there are numerous technical advantages associated with the disclosed embodiments of the invention. For example, in the embodiments described herein, the host operating system can be any modern operating system able to recognize portable storage media and run scripts and/or JavaScript. This alone is a significant improvement over prior art approaches. Also, in the embodiments described herein, the guest operating system can be almost any operating system, past or present. Together, these two features offer significant advantages over prior art systems and methods.

For example, typical prior art host systems and/or guest systems are ordinarily dependent on a specific operating system for the host and/or guest OS. As such, typical prior art systems offer limited connectivity between host systems and guest systems generally. Thus, the near universality of host and guest combinations is a significant improvement over earlier systems and methods.

Additionally, in embodiments disclosed herein, the user can finish work, shut down, and move to a host system of a completely different type, while maintaining the guest OS configuration. As such, in moving to a new host system, the user will still find all of the user's latest customizations, settings, updates and files, just as they were when the guest system was last used. Thus, the embodiments disclosed herein off a continuity that is a significant advantage over what is commonly known as a “Live CD.” Similarly, the disclosed embodiments therefore also provide a significant improvement over other operating systems, such as those that can be configured to boot from a USB flash drive, such as Knoppix, Linux, WindowsPE, BartPE, ReactOS, and other varieties of Ubuntu Linux.

Similarly, from the perspective of the user, some embodiments disclosed herein function like a conventional desktop or laptop computer. That is, the computer environment presented to the user appears to function the same as a conventional desktop or laptop computer, but also possesses the advantage of portability, as well as other advantages. As such, from the user's perspective, the user can customize the content of the device, such as installing various software programs; storing music, photos, and movies; reading e-books; transferring files; storing information; performing backups and downloads; listening to audio books; and reading documents, etc. As described in more detail above, these customizations persist, even as the user moves the device among a plurality of host operating environments.

In another embodiment methods and systems for a new VCE comprise an emulator, that may be an otherwise conventional virtual machine emulator, that uses a single executable file to configure, initialize, and operate a guest OS in a VCE. The emulator that sets up a virtual computer including virtual hardware comprising a virtual motherboard and virtual CPU, and a Basic Input/Output System (BIOS). The virtual hardware and the operating system itself can be merged into a single executable file stored on a PSD. This embodiment has the benefit of not relying on unnecessary components that are otherwise necessary for the function of physical computers.

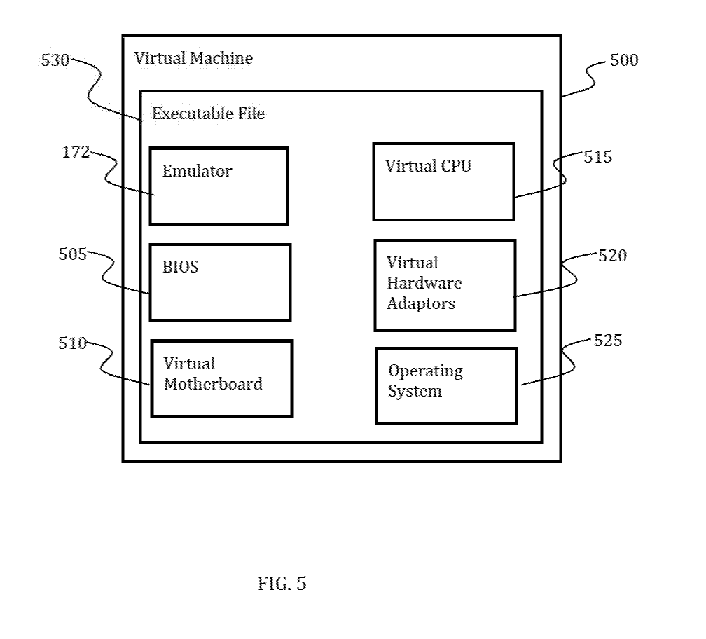

FIG. 5 illustrates a block diagram of a virtual machine 500 in accordance with an embodiment. The virtual machine 500 includes an emulator, such as emulator 172 merged with BIOS 505, a virtual motherboard 510, a virtual CPU 515, and virtual hardware adapters 520, and operating system 525. It should be understood that, in this embodiment, the emulator 172, BIOS 505, virtual hardware (e.g. virtual motherboard 510, and virtual CPU 515), and the operating system 525 can comprise one monolithic executable file 530 of code. Thus, the emulator 172, BIOS 505, virtual hardware, and the operating system 525 are not separate, in the sense that they are all virtual modules instantiated by a single executable software module from initiation, to user interaction, to shutdown. It should be appreciated that this embodiment may take advantage of hardware elements and architecture illustrated in FIG. 1 in order to initialize and execute a virtualized computing environment (VCE), which runs on host system 102 as guest OS processes 140.

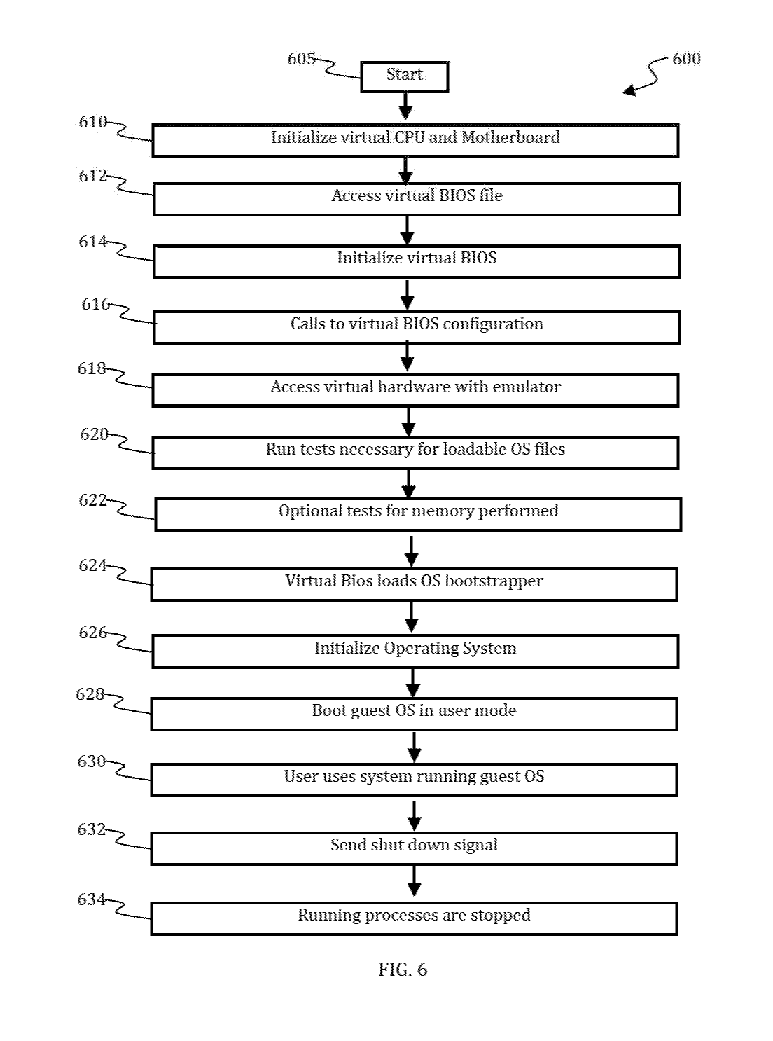

FIG. 6 illustrates a method 600 associated with one embodiment. The method begins at step 605. At step 610, the virtual motherboard and CPU can be initialized. It is noteworthy that, at this step, no hardware calls to the virtual hardware configuration files are made because a single piece of hardware of each desired type is now hardwired to the virtual motherboard and CPU. At step 612, the virtual BIOS file (which is not a separate file) is accessed. The virtual BIOS is initialized at step 614. At step 616, calls to the virtual BIOS configuration file are made. The virtual hardware files are accessed by the emulator at step 618. Note that the virtual hardware does not need to be initialized by the emulator as a separate process. Instead, the hardwired virtual hardware simply comes online.

As indicated at step 620, the virtual BIOS runs all the tests necessary for loading OS files. Tests for memory can be performed at step 622, but are only necessary with respect to volatile memory where the user decides to add more virtual memory. At step 624, the virtual BIOS loads the Operating System boostrapper. Note that the Operating System bootstrapper is hardcoded into the single executable file.

The guest OS initializes at step 626. It is noteworthy again that this does not require a separate file and the virtual hard drive is likewise not a separate file. Because the virtual hardware is hardcoded into the virtual motherboard and speaks directly to the OS kernel, hardware tests aren't needed.

One advantage of the method 600, is that a hardware abstraction layer, which is common in prior art approaches, is no longer needed. Accordingly, the present embodiments are advantageous over prior art methods which require such hardware abstraction layers to be loaded.

At this point the VCE is ready, and boots into user mode running the guest OS at step 628. The user works with the computer in accordance with the user's needs as shown at step 630. When the user is done a shutdown signal can be sent at step 632. The shut down signal triggers running processes to stop at step 634, and the system is safe to shutdown.

It should be understood that the embodiment of the method 600 illustrated in FIG. 6 is exemplary. In certain embodiments the ordering of steps 610-626 may be modified in order to facilitate certain design considerations. For example, in certain embodiments the emulator may set up the virtual hardware before initiating the virtual BIOS. In other embodiments, the virtual BIOS may be initiated at the emulator start up in order to identify the various virtual hardware.

Virtual hardware cannot be damaged in the same way damage to physical hardware can occur. Thus, because the hardware comprises virtual hardware, it need not be unmounted. Similarly, other resources are also virtual and immune to damage that is possible with physical resources. Accordingly, any virtual resources need not be unmounted either. At step 636 the system is released to power off after processes stop. Again, this process is streamlined when compared to physical devices with a hardware abstraction layer because there is no need for unmounting of resources or hardware.

The embodiments can be configured as a singular executable file. The code associated with the executable file generally comprises fewer components and therefore executes faster than comparable physical computers or virtual computers that use separate components. The guest operating system also executes faster and more efficiently without the unnecessary hardware abstraction layer.

The embodiment comprising a single executable file is transportable. As a result the embodiment can be obfuscated, encrypted, checksummed, and efficiently checked for viruses. In particular the trimmed executable code in the single executable file is resistant to computer viruses, because some of the layers or components that are attacked in physical computers do not exist.

In certain embodiments, components out of the virtual Basic Input/Output System (BIOS) can be removed. For example, as new hardware detection, support varieties of different common hardware components (e.g. multiple video cards), support for legacy, non-USB devices and devices not widely supported by virtual environments, such as tape drives, joysticks, SCSI printers are all unnecessary.

In the embodiments disclosed herein, the emulator and the operating system are merged. As such, the operating system does not have to discover its environment. The virtual hardware environment can be largely static, except for a few components, including but not limited to allocated RAM, hard drive size, and other such features. The type of hard drive is always the same and the BIOS does not have to have support for other types of drives and/or drives over or under a certain size. The BIOS utility program can be reduced to a selection of several relevant options.

In certain embodiments, portions of the single executable file can be subjected to a checksum to test if the file has been altered. This checksum can replace traditional BIOS level antivirus methods.

In the embodiments disclosed herein, the bootstrap loader can be configured to understand only one type of bootstrapping for the particular operating system. Several bootstrapper code modules can be included to fit the guest operating system that will be booted in the virtual environment. This can include Linux, ReactOS, Android, or other open source operating systems. In other embodiments, a custom bootstrapper module can be configured to boot closed source operating systems such as Macintosh OS and Windows.

Given the embodiments disclosed certain functions remain necessary. Such functions include checking the serial and parallel ports, verifying the video system, checking the NMI, checking the keyboard, checking the mouse, checking the system RAM, setting shadow RAM areas, checking hardware adaptors, and loading the OS.

Finally, in certain embodiments, unnecessary components of the operating system can be omitted. Most notably, the hardware will not change. The drivers for the virtual hardware can be coded directly into the operating system's kernel.

According to the methods and systems disclosed herein the guest operating system will behave the same as a non-virtual operating system. Internal (and not external) persistence can be maintained. All operating system capabilities and tasks can remain intact and available to the user. New programs can be installed as they would on a non-virtual operating system and the programs will speak directly to the virtual hardware (as opposed to speaking to hardware through a hardware abstraction layer).

Additionally, the embodiments disclosed herein provide access to and/or control of all or some of the host system hardware. For example, in some embodiments, the user can use and/or control the host system CD/DVD/Blu-Ray drives, printers, faxes, scanners, Internet connections, other portable storage devices, hard drives, video cards, mouse, keyboard, speakers, monitor, and sound adapters, for example. One skilled in the art will understand that these devices can also be secured with typical security protocols, and, as such, in some embodiments, access to one or more host system devices can be restricted. Notwithstanding security considerations, in some embodiments, once the user connects the portable storage device, every piece of hardware on the host computer is under the control of the portable storage device, configuring automatically and not requiring any user intervention. In some embodiments, the portable storage device is further adapted to control the host system hardware without robbing, hacking, or invading the host system.

Additionally, the embodiments disclosed herein can be configured to operate from a wide variety of physical media. This feature offers near universality of the portable storage medium and is a significant advantage over the prior art.

Additionally, some of the embodiments disclosed herein offer automatic duration features that are also significant improvements over the prior art. For example, some embodiments provide auto-run and/or auto-configuration, especially with emulators, portable operating systems, and portable applications. Prior approaches have required that the user manually find and run the emulators and scripts to initiate an emulator, which can be scattered over a number of storage locations.

Additionally, the disclosed embodiments also offer versatility in portable operating systems. As described above, some disclosed embodiments can be adapted to combine scripts readable by various operating systems. As such, when the device is attached and mounted by typical computing processes on nearly any host machine configured for auto run, the host computer will automatically find and run a initialization script readable by the host. This feature reduces configuration problems for the user, and improves ease of portability over prior approaches.

Additionally, the disclosed embodiments can be adapted to run as a user-level process on all operating systems. Prior approaches, such as approaches of some Linux systems, for example, typically require at least some administrative privileges to install an emulator in order to run virtual machines or devices. Because the disclosed embodiments can run as a user-level process, the disclosed embodiments allow the user of any system with non-administrative rights to run the virtual computing environment (VCE).

Additionally, the disclosed embodiments can be adapted to ensure that the guest OS does not modify the host OS. Further, the disclosed embodiments can be adapted to ensure that, unless specifically allowed by the user, the guest OS (VCE) restricts sharing of files or any confidential passwords or information with the host system. Together, these features help improve security by maintaining a separation between the guest OS and the host OS.

Other modifications and implementations will occur to those skilled in the art without departing from the spirit and scope of the invention as claimed. Accordingly, the above description is not intended to limit the invention.

Based on the foregoing, it can be appreciated that a number of embodiments, preferred and alternative, are disclosed herein. For example, in one embodiment, a system for conveniently moving an entire computer environment among a plurality of computing platforms comprises a portable storage medium able to couple to a host machine of a computing platform, the portable storage medium storing a single executable file configured to prepare and launch a computer environment based on a guest OS, and the host machine including a computer environment based on a native operating system (OS), the native OS being able to detect and mount the portable storage medium, the native OS also being able to execute the single executable file.

In another embodiment, the single executable file merges at least one of an emulator, BIOS, virtual hardware, and the guest OS. In an embodiment, the virtual hardware comprises at least one of a virtual motherboard and a virtual central processing unit.

In another embodiment, the native OS is one of a Unix-type OS, a Linux-type OS, a Windows-type OS, a Macintosh-type OS, a mobile-type OS, and a modern-type OS. IN an embodiment the guest OS is one of a Unix-type OS, a Linux-type OS, a Windows-type OS, a Macintosh-type OS, a mobile-type OS, and a modern-type OS. In an embodiment, the native OS is one of a Unix-type OS, a Linux-type OS, a Windows-type OS, a Macintosh-type OS, a mobile-type OS, and a modern-type OS; and the guest OS is one of a Unix-type OS, a Linux-type OS, a Windows-type OS, a Macintosh-type OS, a mobile-type OS, and a modern-type OS.

In an embodiment, the computer environment based on the guest OS is further configured to appear to a user as one of a conventional desktop computer environment or a conventional laptop computer environment.

In an embodiment, the portable storage medium is one of a solid-state USB flash drive, a USB-capable traditional hard drive, a MiniSD card, a MicroSD card, a data storage module of a mobile telephone, a data storage module of a camera, a data storage module of an MP3 device, an online storage account, a static network drive, a dynamic network drive, and a drive distributed across networks.

In an embodiment, a checksum can be used to identify changes to the single executable file and prevent viruses. In another embodiment, the computer environment based on the guest OS is executable as a process that does not require administrator rights within the native OS.

In yet another embodiment, a method for conveniently moving an entire computer environment among a plurality of host computers, each host computer having a native computer environment based on a native operating system (OS), the native OS being able to detect and mount a portable storage medium, the native OS also being able to execute an executable script, comprises providing a portable storage medium, storing on the portable storage medium a single executable file configured to prepare and launch a computer environment based on a guest operating system (OS), attaching the portable storage medium to a host computer, running the single executable file on the host computer in order to provide the computer environment based on the guest OS.

In an embodiment, the single executable file merges at least one of an emulator, BIOS, virtual hardware, and said guest OS. In an embodiment, the virtual hardware comprises at least one of a virtual motherboard and a virtual central processing unit.

In another embodiment, the native OS is one of a Unix-type OS, a Linux-type OS, a Windows-type OS, a Macintosh-type OS, a mobile-type OS, and a modern-type OS.

In an embodiment, the guest OS is one of a Unix-type OS, a Linux-type OS, a Windows-type OS, a Macintosh-type OS, a mobile-type OS, and a modern-type OS.

In another embodiment, the native OS is one of a Unix-type OS, a Linux-type OS, a Windows-type OS, a Macintosh-type OS, a mobile-type OS, and a modern-type OS; and the guest OS is one of a Unix-type OS, a Linux-type OS, a Windows-type OS, a Macintosh-type OS, a mobile-type OS, and a modern-type OS.

In another embodiment, the method comprises identifying changes to the single executable file using a checksum to prevent viruses.

In an embodiment, the guest computer environment based on the guest OS is executable as a process that does not require administrator rights within the native OS. In an embodiment, the computer environment based on the guest OS is further configured to appear to a user as one of a conventional desktop computer environment or a conventional laptop computer environment.

In another embodiment, the portable storage medium is one of a solid-state USB flash drive, a USB-capable traditional hard drive, a MiniSD card, a MicroSD card, a data storage module of a mobile telephone, a data storage module of a camera, a data storage module of an MP3 device, an online storage account, a static network drive, a dynamic network drive, and a drive distributed across networks.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A system for conveniently moving an entire computer environment among a plurality of computing platforms, the system comprising:
a portable storage medium able to couple to a host machine of a computing platform, the portable storage medium storing a single executable file configured to prepare and launch a computer environment based on a guest OS; and
the host machine including a computer environment based on a native operating system (OS), the native OS being able to detect and mount the portable storage medium, the native OS also being able to execute the single executable file.

2. The system of claim 1, wherein the single executable file merges at least one of:
an emulator,
BIOS,
virtual hardware, and
said guest OS.

3. The system of claim 2, wherein the virtual hardware comprises at least one of a virtual motherboard and a virtual central processing unit.

4. The system of claim 1, wherein the native OS is one of:
a Unix-type OS,
a Linux-type OS,
a Windows-type OS,
a Macintosh-type OS,
a mobile-type OS, and
a modern-type OS.

5. The system of claim 1, wherein the guest OS is one of:
a Unix-type OS,
a Linux-type OS,
a Windows-type OS,
a Macintosh-type OS,
a mobile-type OS, and
a modern-type OS.

6. The system of claim 1, wherein the native OS is one of:
a Unix-type OS,
a Linux-type OS,
a Windows-type OS,
a Macintosh-type OS,
a mobile-type OS, and
a modern-type OS;
and the guest OS is one of:
a Unix-type OS,
a Linux-type OS,
a Windows-type OS,
a Macintosh-type OS,
a mobile-type OS, and
a modern-type OS.

7. The system of claim 1, wherein the computer environment based on the guest OS is further configured to appear to a user as one of a conventional desktop computer environment or a conventional laptop computer environment.

8. The system of claim 1, wherein the portable storage medium is one of:
a solid-state USB flash drive;
a USB-capable traditional hard drive;
a MiniSD card;
a MicroSD card;
a data storage module of a mobile telephone;
a data storage module of a camera;
a data storage module of an MP3 device;
an online storage account;
a static network drive;
a dynamic network drive; and
a drive distributed across networks.

9. The system of claim 1, wherein a checksum can be used to identify changes to the single executable file and prevent viruses.

10. The system of claim 1, wherein the computer environment based on the guest OS is executable as a process that does not require administrator rights within the native OS.

11. A method for conveniently moving an entire computer environment among a plurality of host computers, each host computer having a native computer environment based on a native operating system (OS), the native OS being able to detect and mount a portable storage medium, the native OS also being able to execute an executable script, the method comprising:
providing a portable storage medium;
storing on the portable storage medium a single executable file configured to prepare and launch a computer environment based on a guest operating system (OS);
attaching the portable storage medium to a host computer;
running the single executable file on the host computer in order to provide the computer environment based on the guest OS.

12. The method of claim 11, wherein the single executable file merges at least one of:
an emulator,
BIOS,
virtual hardware, and
said guest OS.

13. The method of claim 11, wherein the virtual hardware comprises at least one of a virtual motherboard and a virtual central processing unit.

14. The method of claim 11, wherein the native OS is one of:
a Unix-type OS,
a Linux-type OS,
a Windows-type OS,
a Macintosh-type OS,
a mobile-type OS, and
a modern-type OS.

15. The method of claim 11, wherein the guest OS is one of:
a Unix-type OS,
a Linux-type OS,
a Windows-type OS,
a Macintosh-type OS,
a mobile-type OS, and
a modern-type OS.

16. The method of claim 11, wherein the native OS is one of:
a Unix-type OS,
a Linux-type OS,
a Windows-type OS,
a Macintosh-type OS,
a mobile-type OS, and
a modern-type OS;
and the guest OS is one of:
a Unix-type OS,
a Linux-type OS,
a Windows-type OS,
a Macintosh-type OS,
a mobile-type OS, and
a modern-type OS.

17. The method of claim 11, further comprising identifying changes to the single executable file using a checksum to prevent viruses.

18. The method of claim 11, wherein the guest computer environment based on the guest OS is executable as a process that does not require administrator rights within the native OS.

19. The method of claim 11, wherein the computer environment based on the guest OS is further configured to appear to a user as one of a conventional desktop computer environment or a conventional laptop computer environment.

20. The method of claim 11, wherein the portable storage medium is one of:
a solid-state USB flash drive;
a USB-capable traditional hard drive;
a MiniSD card;
a MicroSD card;
a data storage module of a mobile telephone;
a data storage module of a camera;
a data storage module of an MP3 device;
an online storage account;
a static network drive;
a dynamic network drive; and
a drive distributed across networks.
